(19) United States
(12) Patent Application Publication
(10) Pub. No.: US 2008/0245959 A1
(43) Pub. Date: Oct. 9, 2008

(54) ADJUSTED LASER BEAM CONTAMINANT PROCESSING

(76) Inventor: Kathleen A. Ball-Wolfe, Mountain Ranch, CA (US)

Correspondence Address: DAVID E. LOVEJOY, REG. NO. 22,748, 102 REED RANCH ROAD, TIBURON, CA, 94920-2025, US

(21) Appl. No.: 11/696,164

(22) Filed: Apr. 3, 2007

(51) Int. Cl. G01V 5/00

(52) U.S. Cl. 250/253; 250/492.1

(57) ABSTRACT

Processing soil in a land area contaminated with one or more contaminates that are elements having one or more respective NMR values. Examples of the contaminates are the heavy metals. The processing includes generating a plurality of base laser beams at base frequencies with one base laser beam for each NMR value. The base laser beam is typically 635 nm corresponding to a base frequency of 1.5748 MHz. The base frequency is adjusted in response to the NMR values to form an adjusted processing beam. The adjusted processing beam is focused to form focused processing beam. The soil is then irradiated with a scan pattern that covers the land area.

### TECHNICAL FIELD

This invention relates to laser devices for toxic cleanup and more particularly low-energy laser devices for processing lead, mercury and other contaminants in soil and other contaminated materials.

### BACKGROUND OF THE INVENTION

The problems resulting from contamination in the environment are receiving great attention in an increasingly industrialized world with an increasing population.

Many sources of contamination exist. For example, lead and mercury metals have great toxicity. As a class, heavy metals represent a significant source of pollution in the environment. Heavy metals include arsenic, beryllium, lead, cadmium, chromium, nickel, zinc, mercury and barium. Often, these metals are highly toxic whether in organic or inorganic form.

Heavy metals result in contamination in various ways. Heavy metals are present in fossil fuels such as coal, oil and natural gas, in biomass, in ores and in wastes. Heavy metals are volatilized in the hot regions of processing units such as boilers, incinerators or furnaces and are released into the environment as airborne emissions as a result of combustion, incineration and other processes and as a result of waste discard. As hot gases are cooled, less volatile metal species (for example, cadmium and lead) condense onto particles of ash entrained in the gas stream, while more volatile metals (e.g., arsenic and mercury) remain in the gas phase, where they end up as airborne emissions. Contaminants often leach into soils and groundwater from airborne particles, from ash, from waste and from other sources. Often contaminants appear in landfills, mining soil discards and process effluents.

Attempts to control toxic metal emissions that are in particulate form often use bulk solid sorbents to chemically adsorb various metals thereby reducing their discharge into the atmosphere. Mercury emissions from combustion sources, unlike most other heavy metals that are emitted in particulate forms, are released mainly in the elemental form in the vapor phase. Vapor phase elemental mercury is not easily captured and often undergoes biological processes in the atmosphere to form even more toxic mercury compounds such as methyl mercury. Mercury also bio-concentrates in vegetation and fish which through consumption leads to adverse health effects in human beings and predator animals.

One widely used technique to remove mercury and other contaminates is through activated carbon filtering. However, the use of activated carbon is limited because of its poor capacity, low temperature range, regeneration and slow adsorption rate.

Electrostatic precipitators and filters are common particulate removal systems for removing toxic particulate material. However, electrostatic precipitators are often unable to remove materials having inadequate resistivity and hence are unable to retain an adequate electrical charge.

While the processing of heavy metals and other contaminants is being pursued vigorously to help cleanup and preserve the environment, there still remains a need for much improved contaminant processing.

### SUMMARY

The present invention is a method and apparatus for processing soil in a land area contaminated with one or more contaminates that are elements having one or more respective NMR values. By way of example, the contaminates are heavy metals such as arsenic, beryllium, lead, cadmium, chromium, nickel, zinc, mercury and barium. The processing includes generating a plurality of base laser beams at base frequencies with one base laser beam for each NMR value. The base laser beam is typically 635 nm corresponding to a base frequency of 1.5748 MHz. The base frequency is adjusted in response to the NMR values to form an adjusted processing beam. The adjusted processing beam is focused to form focused processing beam. The soil is then irradiated with a scan pattern that covers the land area.

In one embodiment, the adjusting step is performed using pulse width modulation where a pulse width is correlated to the NMR value.

In one embodiment, the NMR value is about 20.858 and the contaminant is lead. In another embodiment, NMR value is about 19.910 or about 6.611 and the contaminant is mercury. In a still other embodiment, NMR value is about 17.122 and the contaminant is arsenic.

In one embodiment, soil in a land area is processed with the processing beam having a beam width and with the irradiation performed by scanning the land area with a scan pattern that covers the land area with the processing beam. In a particular embodiment, the scan pattern is in X-axis and orthogonal Y-axis directions with an offset between scans approximately equal to the beam width.

In one embodiment, the scan pattern is followed by a vehicle where the vehicle is tracked by a GPS system.

In one embodiment, a plurality of individual laser beams, having individual beam widths, are grouped together to form a composite processing beam for irradiating the soil.

The foregoing and other objects, features and advantages of the invention will be apparent from the following detailed description in conjunction with the drawings.

### BRIEF DESCRIPTION OF THE DRAWINGS

FIG. 1 depicts a laser device focusing a laser beam on a material to be treated.

FIG. 2 depicts different ON/OFF modulations for adjusting the laser beam.

FIG. 3 depicts a laser device providing a laser beam that penetrates into a material to be treated.

FIG. 4 depicts a laser device generating a laser beam of an oval shape.

FIG. 5 depicts another laser device generating a laser beam as a long and narrow stripe.

FIG. 6 depicts a laser device having multiple laser beams focused on a material to be treated.

FIG. 7 depicts an eight-unit embodiment of laser units for use in the laser device of FIG. 6.

FIG. 8 depicts an expanded view of three of the eight laser units of FIG. 7.

FIG. 9 depicts a scan pattern for scanning an area with a single-unit laser device of FIG. 1.

FIG. 10 depicts a utility vehicle for transporting a laser device including the eight-unit embodiment of laser units of FIG. 6, FIG. 7 and FIG. 8.

FIG. 11 depicts a scan pattern for scanning an area with a multi-unit laser device of FIG. 10.

FIG. 12 depicts a scan grid for scanning an area with a multi-unit laser device of FIG. 10.

### DETAILED DESCRIPTION

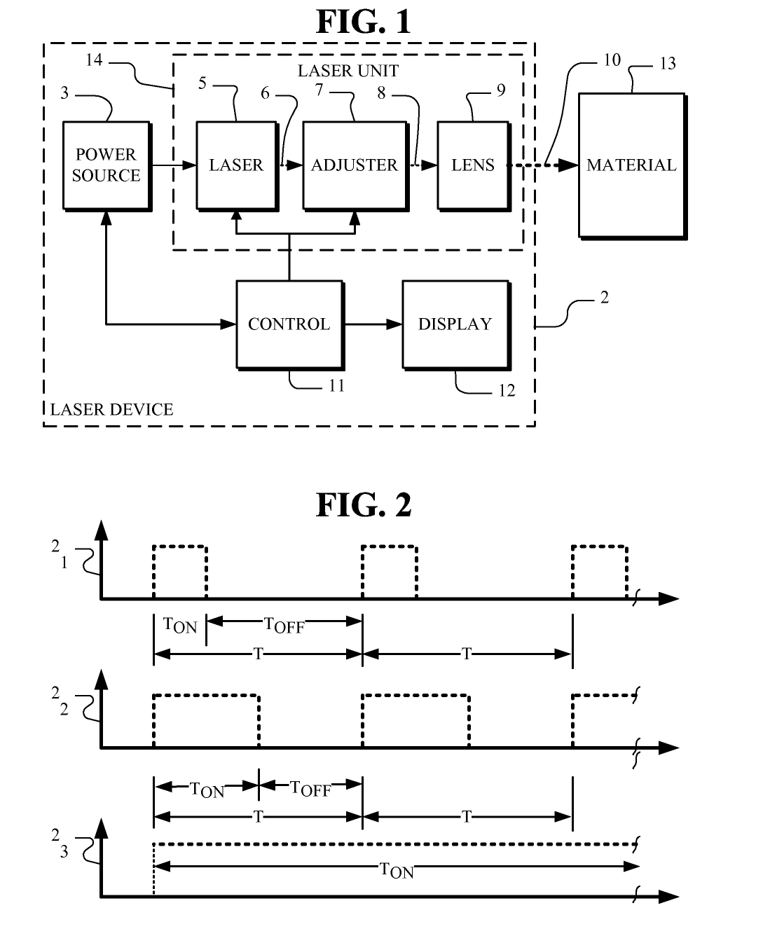

In FIG. 1, the laser device 2 includes laser unit 14, a power source 3, a control unit 11, and a display 12. The laser device 2 is hand-held or mounted on a vehicle such as an SUV, ATV, tractor or other mechanized device. The laser beam 10 output from the laser device 2 is a processing beam that impinges on and irradiates the material 13. When the beam size of processing beam 10 is small relative to the size of material 13, the processing beam is scanned with a scan pattern relative to material 13 so that over time an area and a volume of the material 13 is scanned and irradiated. The area and volume scanned can be the entire material or a portion or region thereof. The control unit 2 functions to control the laser device 2 and typical receives manual inputs from a person as an operator or receives automatic inputs under computer program or other automated control when the operator is electronic. The display 12 displays operating information such as power levels, frequency, modulation and other adjustment parameters useful in the operation and control of the laser device 2. The power source 3 typically includes a battery power supply together with regulators for providing voltage and current levels used in the laser unit 14, control 11 and display 12. Conventional alternating power sources such as provided by conventional power connections to buildings can be employed and when used is converted to direct current and voltage in power source 3.

In FIG. 1, the laser unit 14 in laser device 2 includes a laser 5, an adjuster 7 and a lens 9. The laser 5 is typically a well-known device producing a laser beam that is generally in the 400-700 nm range. Laser 5 is any conventional laser such as is Helium-Neon laser having a 632 nm wavelength or a semiconductor diode laser with a broad range of wavelengths with a range of about 600-800 nm. For a light-weight, portable laser device 2, a semiconductor laser diode is employed that produces a beam having a wavelength of about 635 nm. The beam having a wavelength of 635 nm is light in the red range of the visible spectrum. Other suitable wavelengths include ultraviolet light (approx. 1-400 nm) or infrared (approx. 700-105 nm).

When the beam 6 has a wavelength of period, P, the laser 5 has an operating frequency (F) given by 1/P=F. In the example of P=635 nm, the frequency, F=1.5748 MHz is determined as follows:

1/(635×10⁻⁹ m)=0.0015748×10⁹ Hz=1.5748 MHz

The laser unit 2 produces the laser processing beam 10 by processing the laser light 6 from laser 5. In one embodiment, the laser 5 is a semiconductor laser diode producing the laser beam 6 with a base wavelength of about 635 nm at a base frequency of about 1.5748 MHz.

The base laser beam 6 is adjusted as a function of an NMR frequency of a contaminant element in material 13 to be processed and when adjusted forms the adjusted processing beam 8. The adjustment is made by control 11 providing a control input either directly to laser 5 or to an adjuster 7. In some embodiments, tunable solid-state laser diodes are employed in laser 5 or adjuster 7. In one example, the adjuster 7 is a modulator for pulse-width modulation of the ON/OFF time of the beam 8. The beam 8 is derived from the beam 6 with the ON/OFF or other adjustment made. In other embodiments, adjuster 7 is a multiplier for multiplying the frequency of the beam 6 by higher or lower frequency values as a function of an NMR frequency. Any type of adjuster, such as a frequency multiplier, may be employed for introducing values into the beam 10 as a function of NMR frequencies.

In FIG. 1, the lens 9 typically includes a collimating optical lens, an optical image shaping lens and other optical lenses including prisms and filters disposed in series as is appropriate for controlling the adjusted processing beam 8 and form the focused processing beam 10. Alternatively, electrical and mechanical “lenses” can be used to control the size, shape and other parameters of the focused processing beam 10.

In FIG. 2, different ON/OFF modulation waveforms 2-1, 2-2 and 2-3 are shown for adjusting the laser beam 10 of FIG. 1. In waveform 2-1, the period between the pulses (shown as broken lines) is T and over the period T each pulse is ON during the T_{ON} time and is OFF during the T_{OFF} time where T_{ON}+T_{OFF}=T. In one embodiment, the ON/OFF timing is done over 100,000 increments from 00000 to 99999 where for 00000, the beam is always ON and for 99999 the beam is always OFF. In FIG. 2, waveform 2₃ represents a 00000 value, waveform 22 represents about a 49999 value and waveform 2₁ represents about a 20858 value.

In another embodiment, adjuster 7 is a variable frequency modulator operating over a modulation range, for example from 1 to 25 MHz. In such an embodiment, the control 11 provides an input to select the NMR frequency for the contaminant element to be processed, for example, 20.858 MHz. The NMR frequency in adjuster 7 is then mixed with the 1.5748 MHz frequency of beam 6 to provide the modulated signal 8 which is focused in lens 9 to form the focused processing beam 10.

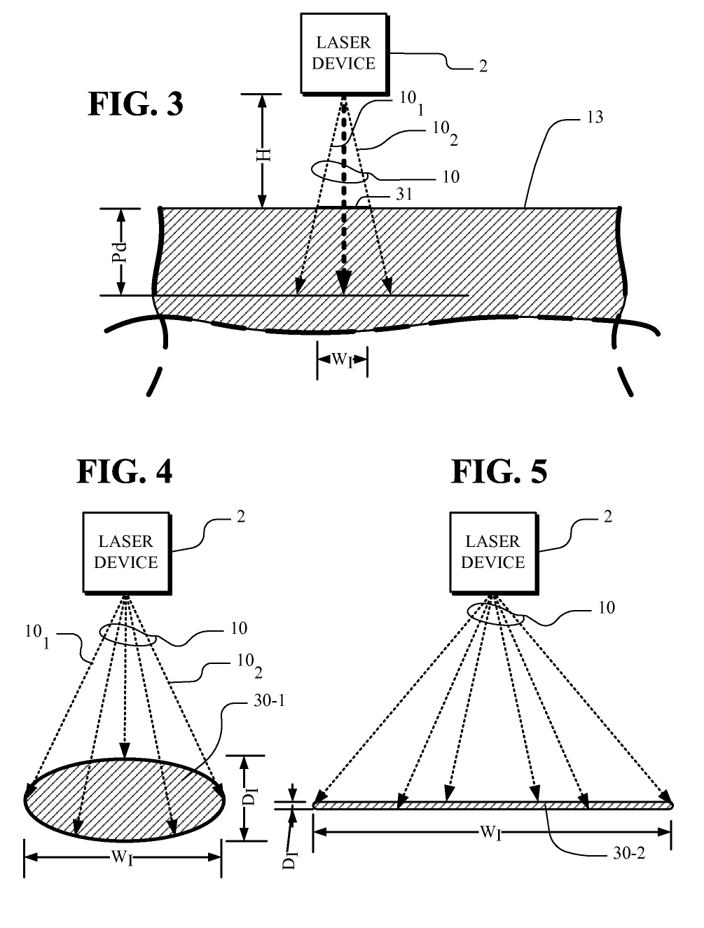

In FIG. 3, the laser device 2 is at a height, H, above the surface of the material 13 to be processed. The height, H, is typically from 0.3 meter to 4 meters and in one embodiment is at 1 meter. With such an embodiment, the beam 10 is focused by the lens 9 of FIG. 1 to spread as shown by rays 10₁ and 10₂ to an image width, W_{I}, for image 31 at the surface of material 13. The beam 10 penetrates to a depth, Pd. The depth of penetration is a function of, among other things, the power and frequency of the beam 10. For example, the penetration depth, Pd, at a 25 MHz frequency using 1000 volt pulses has been measured in soil down to 28 meters. With lower power outputs the penetration depth is reduced. With a low power laser, for example a laser with a 5 milliwatt output at 1.5748 MHz, effectively has a penetration depth of 3 meters or more in soil.

One example of an instrument that produces a 5 milliwatt output at 1.5748 MHz is available from ERCHONIA MEDICAL of McKinney, Tex. under the product name Erchonia 3LT™ Laser—PL5000. Such instruments are used in the medical field on the human body and are claimed to have therapeutic value. For human body use, low frequency duty cycle modulations are typically from 1 Hz to 100 Hz and have no correlation to NMR frequencies.

In FIG. 4, laser device 2 generates laser beam 10 with an oval shape image 30-1 having a width, W_{I}, and having a depth, D_{I}. In one embodiment, the width is about 0.5 meter and a depth is about 0.3 meter when laser device 2 is positioned at a height, H, (as shown in FIG. 3) of about 1 meter.

In FIG. 5, laser device 2 generates laser beam 10 with a stripe-shape image 30-2 having a width, W_{I}, and having a depth, D_{I}. In one embodiment, the width is about 1.5 meters and a depth is about 0.05 meter when laser device 2 is positioned at a height, H, (as shown in FIG. 3) of about 1 meter. The FIG. 4 and FIG. 5 image sizes and shapes are representative examples. A large variety of image shapes and sizes are possible.

It has been found that removal of the toxic properties of materials is effectively achieved when the material, and the contaminate in the material, is irradiated with a beam adjusted as a function of the nuclear magnetic resonance (NMR) frequency of the contaminate. The NMR values for many elements in the periodic table are well known. By way of example, values for heavy metals are given in the following TABLE 1:

| Metal | MASS (a.m.u) | NMR (MHz) |
|---|---|---|
| Arsenic (As) | 74.9216 | 17.122 |
| Barium (Ba) | 134.9056 | 09.934 |
| Barium (Ba) | 136.9056 | 11.112 |
| Beryllium (Be) | 9.0122 | 14.051 |
| Cadmium (Ca) | 110.9042 | 21.200 |
| Cadmium (Ca) | 112.9046 | 22.178 |
| Chromium (Cr) | 52.9407 | 05.652 |
| Lead (Pb) | 206.9759 | 20.858 |
| Mercury (Hg) | 198.9683 | 19.910 |
| Mercury (Hg) | 200.9703 | 06.611 |
| Nickel (Ni) | 60.9310 | 08.936 |
| Zinc (Zn) | 67.9249 | 06.256 |

In an example where soil is contaminated with lead (Pb), the NMR value for lead is 20.858 MHz. The digits 20858 are used a the input as described in connection with FIG. 2 for a five-digit embodiment and the modulation appears as show in waveform 2₁ of FIG. 2. If the control parameters use a different number of digits, then the input is appropriately modified to include the most significant digits. For example, if a four-digit embodiment is employed, the digits 20858 in the lead example are rounded to 2086 and the result is essentially the same as waveform 2₁ of FIG. 2.

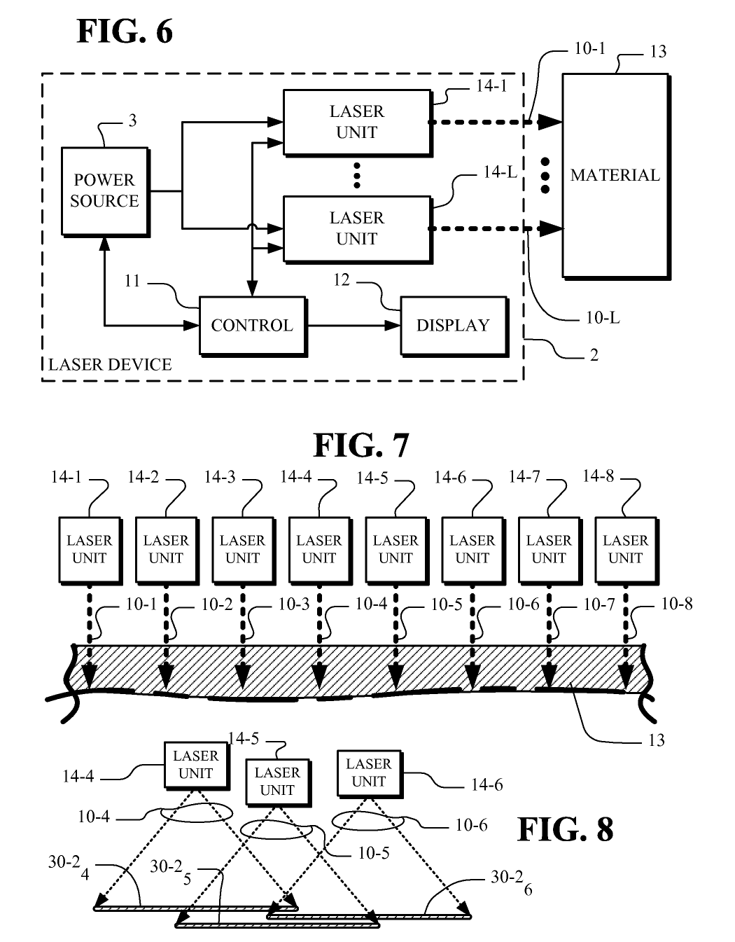

In FIG. 6, the laser device 2 includes a plurality of laser units 14, including laser units 14-1, 14-2, . . . , 14-L, a power source 3, a control unit 11, and a display 12. The laser device 2 is hand-held or mounted on a vehicle such as an off-road SUV, ATV, tractor or other mechanized device. The laser beams 10, including beams 10-1, . . . , 10-L output from the laser units 14-1, . . . , 14-L, respectively from laser device 2 impinge on the material 13. When the beam sizes of the beams 10 are small relative to the size of material 13, the beams are scanned relative to material 13 so that over time an area and a volume of the material 13 is scanned. The area and volume scanned can be the entire material 13 or a portion or region thereof. The control unit 2 functions to control each of the laser units 14 of laser device 2 and typical receives manual inputs from a person as an operator or receives automatic inputs under computer program or other automated control when the operator is electronic. The display 12 displays operating information such as power levels, frequency, location, modulation and other parameters useful in the operation and control of the laser device 2. The power source 3 typically includes a battery power supply together with regulators for providing voltage and current levels used in the laser units 14, control 11 and display 12. In FIG. 6, each of the laser units 14 in laser device 2 includes a laser 5, an adjuster 7 and a lens 9 as shown and described in connection with FIG. 1. Each of the laser units 14 produces a laser beam that is generally in the 400-700 nm range and typically includes a semi-conductor laser diode that produces a beam having a wavelength of about 635 nm. Other suitable wavelengths include ultraviolet light (approx. 1-400 nm) or infrared (approx. 700-105 nm).

In FIG. 7, an eight-unit embodiment of laser units 14 of FIG. 6 includes laser units 14-1, 14-2, . . . , 14-8 for use in the laser device 2 of FIG. 6. The laser beams 10, including beams 10-1, . . . , 10-8 output from the laser units 14-1, . . . , 14-8, respectively, impinge on the material 13. The beam sizes of the beams 10-1, . . . , 10-8 may be individually small, but collectively they are, in the embodiment of FIG. 7, eight times wider than a single one of the beams 10. Typically, the beams are scanned relative to material 13 so that over time an area and a volume of the material 13 is scanned. The area and volume scanned can be the entire material 13 or a portion or region thereof. The control unit 2 of FIG. 6 functions to control each of the laser units 14 of FIG. 7. The display 12 displays operating information such as power levels, frequency, location, modulation and other parameters useful in the operation and control of each of the laser units 14.

In FIG. 8, three of the adjacent laser units of FIG. 7 are shown in greater detail. In particular, laser units 14-4, 14-5 and 14-6 have beams 10-4, 10-5 and 10-6 creating images 30-2₄, 30-2₅ and 30-2₆, respectively. The images 30-2₄ and 30-2₆ overlap in the width direction even without the central image 30-2₅ so that the image 30-2₅ can be used for a different NMR frequency. This alternating relationship can be applied to all laser units 14 in FIG. 7. For example, first ones of the laser units 14 are tuned to a first NMR frequency and alternate second ones of the laser units 14 are tuned to a second NMR frequency. As an example, first laser units 14-1, 14-3, 14-5 and 14-7 are tuned to the first NMR frequency and second laser units 14-2, 14-4, 14-6 and 14-8 are tuned to a second NMR frequency. While FIG. 8 is one example of two different NMR frequencies in a single row array of laser units 14-1, 14-2, . . . , 14-8, multiple rows of laser units with different overlapping images in an array so that any number of different NMR frequencies can be simultaneously processed.

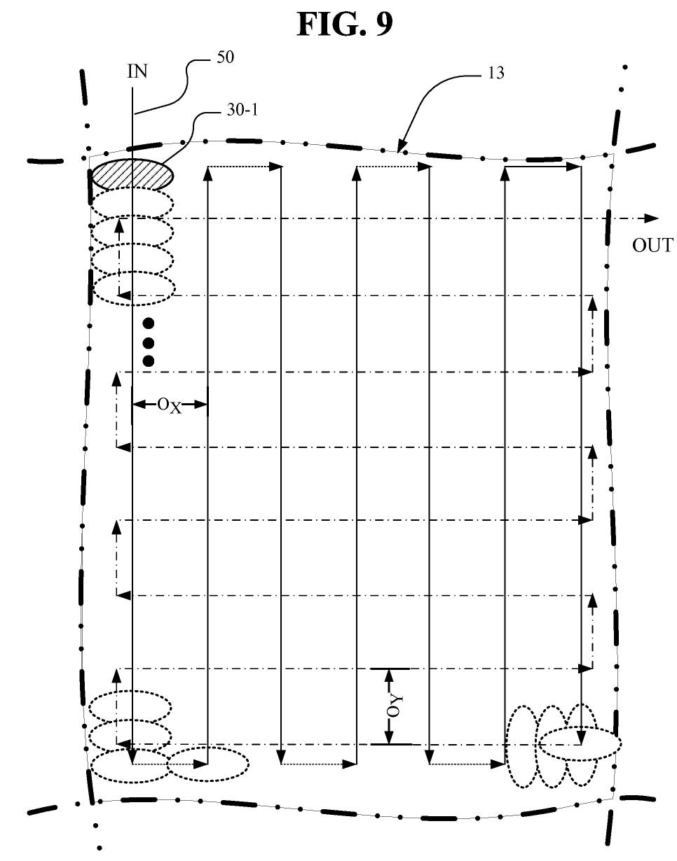

In FIG. 9, a scan pattern 50 is followed for scanning an area of material 13 with a single-unit laser device having an image of the size and shape of image 30-1 of FIG. 4. Typically, the material 13 is ground soil in a land plot that has been contaminated with a heavy metal such as lead. The size of the land plot may be small, for example, the size of a yard of a single family dwelling or may be large, for example, many square miles containing the spoils of mines. The scan pattern 50 in FIG. 9 follows an X-Y rectangular grid starting at IN and ending at OUT. The laser image 30-1 is first scanned in a first direction, corresponding to the vertical Y-axis direction of arrows in FIG. 9, with a repeat offset, O_{X}, between vertical scans equal to approximately the width, W_{I}, of the image 30-1. Second, the laser image 30-1 is scanned in a second orthogonal direction, corresponding to the horizontal X-axis direction of arrows in FIG. 9, with a repeat offset, O_{Y}, between horizontal scans equal to approximately the width, W_{I}, of the image 30-1. With this scan pattern the entire land plot comprising material 13 of FIG. 9 is scanned by the single image 30-1.

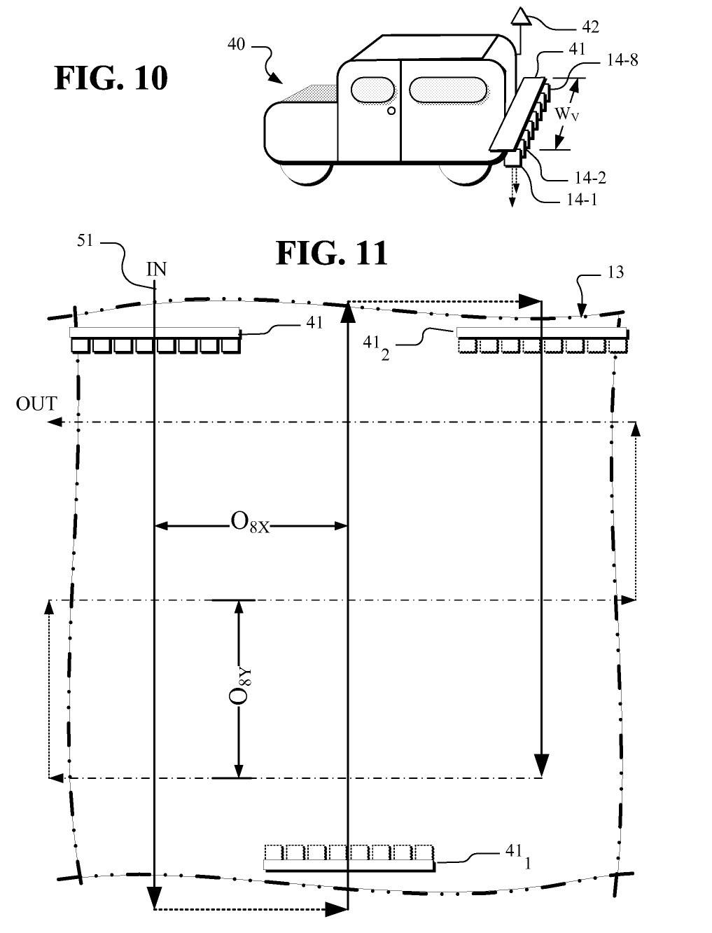

In FIG. 10, a utility vehicle 40 includes a multi-unit laser device 41 including an eight-unit embodiment of laser units 14-1, . . . , 14-8 of the type described in connection with FIG. 6, FIG. 7 and FIG. 8. The laser units 14-1, . . . , 14-8 are typically of the type having stripe images as shown and described in connection with FIG. 5. The width, Wᵥ, of eight of the images 30-2 produced by the laser units 14-1, . . . , 14-8 of multi-unit laser device 41 is much greater than the width of the single image 30-1 of FIG. 4 used in the scan of FIG. 9.

In FIG. 11, a scan pattern 51 is followed for scanning an area of material 13 with the multi-unit laser device 41 of FIG. 10. The laser units 14-1, . . . , 14-8 are typically of the type having stripe images having the size and shape as shown and described in connection with image 30-2 of FIG. 5. Typically, the material 13 is ground soil in a land plot that has been contaminated with a heavy metal such as lead. The size of the land plot of material 13 may be small, for example, the size of a yard of a single family dwelling or may be large, for example, many square miles containing the spoils of mines. The scan pattern 51 in FIG. 11 follows an X-Y rectangular grid starting at IN and ending at OUT. The laser images 30-2 of the multi-unit laser device 41 are first scanned in a first direction, corresponding to the vertical Y-axis direction of the scan arrows in FIG. 11, with a repeat offset, O_{8X}, between vertical scans equal to approximately the width, Wᵥ, of the multi-unit laser device 41 of FIG. 10. Second, the multi-unit laser device 41 is scanned in a second orthogonal direction, corresponding to the horizontal X-axis direction of arrows in FIG. 11, with a repeat offset, O_{8Y}, between horizontal scans equal to approximately the width, W_{I}, of the images 30-2 equal to approximately the width, Wᵥ, of the multi-unit laser device 41 of FIG. 10. With this scan pattern the entire land plot comprising material 13 of FIG. 11 is scanned by the multi-unit laser device 41 of FIG. 10. In FIG. 11, the offsets O_{8X} and O_{8Y} in FIG. 11 are more than eight times larger than the offsets O_{X} and O_{Y} in FIG. 9 and hence the scanning in FIG. 11 has about eight times greater efficiency than the scanning of FIG. 9.

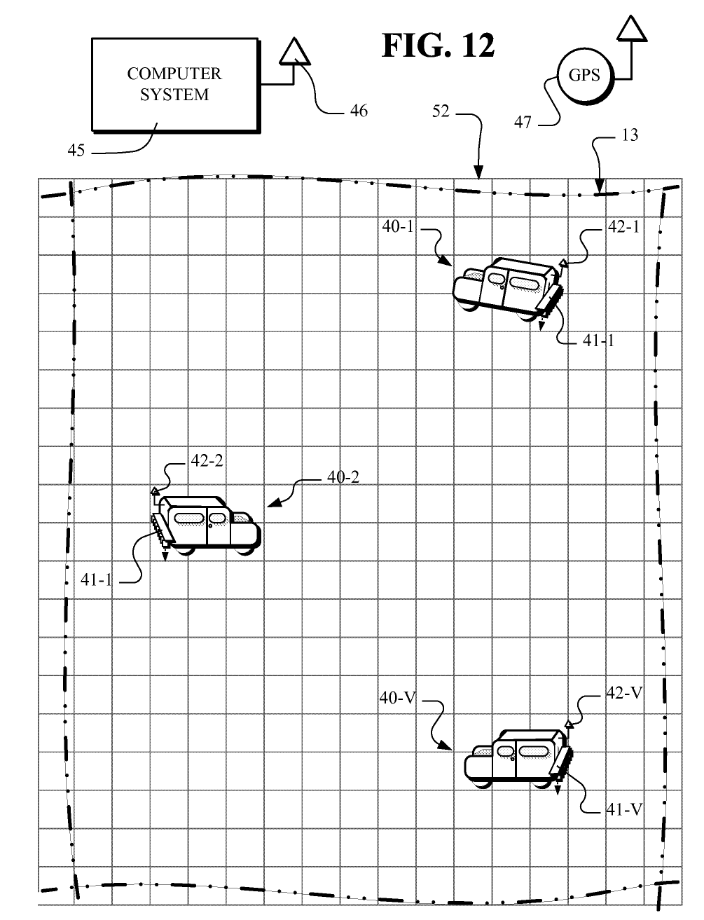

In FIG. 12, scan grid 52 is used from for scanning the area 13 with one or more multi-unit laser devices 41 of FIG. 10. The example of FIG. 12 includes a number of vehicles 40 including vehicles 40-1, 40-2, . . . ,40-V. Each of the vehicles 40-1, 40-2, . . . ,40-V includes a multi-unit laser device 41 including the devices 41-1, 41-2, . . . ,41-V, respectively. Also, each of the vehicles 40-1, 40-2, . . . ,40-V includes a communication unit 42 including the communication units 42-1, 42-2, . . . ,42-V, respectively. The communication units 42 are for transmitting and receiving signals including Global Positioning Signals (GPS) from a GPS satellite system 47.

The GPS system defines the grid 51 over the area 13. The resolution of the GPS grid 51 is greater than scan width Wᵥ of the multi-unit laser devices 41. In FIG. 12, computer system 45 includes a communication unit 46 for transmitting and receiving signals including Global Positioning Signals (GPS) from the GPS satellite system 47 and including scanning information to and from the communication units 42 of the vehicles 40.

The scanning process of FIG. 12 in one embodiment tracks the GPS position of each of the vehicles 40-1, 40-2, . . . ,40-V during a scan session. Each of the vehicles 40-1, 40-2, . . . ,40-V detects the GPS signal from satellite 47 and stores the GPS position of the vehicle for each time increment. The scan information is typically relayed to the computer system 45 in real time concurrently with movement of the vehicle. Alternatively, the information is stored in the vehicle and subsequently uploaded to computer system 45.

The scan information includes the vehicle number, the NMR frequencies being used by the vehicle, the GPS location, the time, the accumulated time at the GPS location, the power level. In this manner, a record is made for every GPS location in the area 13. The drive patterns of the vehicles 40 do not necessarily follow XY scanning as described in connection with FIG. 9 and FIG. 11. The computer system 45 provides a map of all GPS grid locations that have not received adequate exposure and issues commands to alert the vehicles 40 of the need for further scanning in particular GPS locations.

While the invention has been particularly shown and described with reference to preferred embodiments thereof it will be understood by those skilled in the art that various changes in form and details may be made therein without departing from the scope of the invention.

1. A method of processing a material contaminated with an element having an NMR value comprising,
generating a laser beam at a base frequency,
adjusting the base frequency in response to the NMR value to form an adjusted processing beam,
irradiating the material with the processing beam.

2. The method of claim 1 wherein said adjusting step is a pulse width modulation having a pulse width correlated to the NMR value.

3. The method of claim 2 wherein said NMR value is about 20.858 and said contaminant is lead.

4. The method of claim 2 wherein said NMR value is about 19.910 or about 6.611 and said contaminant is mercury.

5. The method of claim 2 wherein said NMR value is about 17.122 and said contaminant is arsenic.

6. The method of claim 1 wherein said material is soil in a land area and wherein said processing beam has a beam width and wherein said irradiating step is performed by scanning said land area with a scan pattern to cover the land area with the processing beam.

7. The method of claim 6 wherein the scan pattern is in X-axis and orthogonal Y-axis directions with an offset between scans approximately equal to said beam width.

8. The method of claim 6 wherein the scan pattern is tracked by a GPS system.

9. The method of claim 6 wherein a plurality of individual laser beams, having individual beam widths, form said processing beam width.

10. A method of processing soil in a land area contaminated with one or more elements having one or more respective NMR values comprising,
generating a plurality of base laser beams at base frequencies, one base laser beam for each NMR value,
adjusting the base frequencies in response to the NMR values to form adjusted processing beams,
focusing the adjusted processing beams to form focused processing beams,
irradiating the soil concurrently with each of the focused processing beams with a scan pattern that covers the land area.

11. The method of claim 10 wherein the base frequencies are approximately 1.5748 MHz.

12. The method of claim 10 wherein the focused processing beams are irradiated from a vehicle.

13. The method of claim 12 wherein the vehicle receives a GPS signal and records GPS positions along the scan pattern.

14. The method of claim 10 wherein groups of individual laser beams have the same NMR values and where laser beams for the same group are juxtaposed to form a composite beam having a composite beam width and whereby the irradiating step is performed by scanning the land area with a scan pattern in X-axis and Y-axis directions with an offset between scans approximately equal to said composite beam width.

15. An apparatus for processing soil in a land area contaminated with one or more contaminants comprising,
one or more laser devices, each laser device including
one or more laser units, each laser unit including,
a laser for generating a laser beam at a base frequency,
an adjuster for adjusting the base frequency in response to a particular control value to form a particular adjusted processing beam,
a lens for focusing the adjusted processing beam to form a focused processing beam,
a control unit providing the particular control value to said laser unit,
a power source providing power to the laser devices and the control unit,
a vehicle supporting said laser devices and for traveling over the land area to irradiate the soil with the processing beam from each laser unit.

16. The apparatus of claim 15 wherein the contaminants are elements having one or more respective NMR values and said particular control value is derived from a particular NMR value for a particular contaminant.

17. The apparatus of claim 16 wherein said vehicle includes a rack for mounting groups of laser units having processing beams derived from the same NMR value and where laser beams for the same group are juxtaposed to form a composite beam having a composite beam width and where when the vehicle travels over the land area with a scan pattern in X-axis and Y-axis directions with an offset between scans approximately equal to said composite beam width, all of the soil in the land area is irradiated.

18. The apparatus of claim 16 wherein said contaminant is lead and said particular NMR value is about 20.858.

19. The apparatus of claim 16 wherein said contaminant is mercury and said particular NMR value is about 19.910 or about 6.611.

20. The apparatus of claim 15 wherein the base frequency is approximately 1.5748 MHz.
